(19) United States
(12) Patent Application Publication
(10) Pub. No.: US 2002/0087488 A1
(43) Pub. Date: Jul. 4, 2002

(54) System and method of tracking vehicle information and bill consolidation

(76) Inventors: Ron Fordahl, Plymouth, MN (US); Steve Greenway, Prior Lake, MN (US)

Correspondence Address: Daniel G. Chapik, DORSEY & WHITNEY LLP, Suite 1500, 50 South Sixth Street, Minneapolis, MN, 55402-1498, US

(21) Appl. No.: 10/012,912

(22) Filed: Nov. 6, 2001

Related U.S. Application Data
(60) Provisional application No. 60/246,378, filed on Nov. 7, 2000.

(51) Int. Cl. G06F 17/00

(52) U.S. Cl. 705/400

(57) ABSTRACT

A server company can track expenditures for a client company's individual vehicles and fleets of vehicles. The server company can automatically take care of paying the bills relating to outside service repairs from multiple vendors and forward a single itemized bill to the client company. The server company can also notify the client company regarding usage characteristics of various types of vehicles, expenditure trends, and even notify the client company when vehicle needs routine maintenance. The present invention reduces the expenditures a client company associates with maintaining a vehicle fleet, whether the vehicles are leased or owned by the client company

### CROSS-REFERENCE TO RELATED APPLICATION(S)

This application claims priority from U.S. provisional patent application No. 60/246,378 that was filed on Nov. 7, 2000 and which is herein incorporated by reference in its entirety.

### FIELD OF THE INVENTION

The invention generally relates to electronically tracking and reporting usage information. More particularly, this invention relates to tracking and reporting usage information relating to a vehicle fleet.

### BACKGROUND OF THE INVENTION

Over the lifetime of a motor vehicle, the vehicle may require routine maintenance, repair of broken systems or parts, and generate other expenses and performance checks. Keeping track of the various routine checks and maintenance operations performed on a vehicle may be time consuming and expensive. Companies with a fleet of vehicles may have difficulties centralizing their costs, particularly because they often receive services from a variety of suppliers or internal departments. This lack of centralization can make it difficult for companies to determine fleet policies, implement fleet policies, influence driver behavior, and keep overall costs down.

Another difficulty with a non-centralized tracking system is bill payment. Receiving and processing bills generated from any work done on the vehicles, including forwarding a payment, may be expensive. Paying bills and tracking information may require additional personnel and additional facilities, both of which may be better utilized for other purposes. The amount of time and expense required to track usage information and billing is increased when the vehicle is owned or leased by an organization having a large vehicle fleet. For example, some fleets may have up to several hundred, or several thousand, cars. Fleet vehicles vary and may include ordinary vehicles used for driving individuals or groups, larger trucks for hauling materials and goods, buses or various other vehicle types. Although automobiles and various truck types are common items for which usage information may be important, tracking may also be important for other pieces of equipment such as, for example, construction equipment. As can be easily appreciated, keeping track of the money spent on maintenance and repair of these vehicles can greatly increase the operating costs of such a fleet.

When a company owning or leasing a vehicle has repair or maintenance work done, the company usually desires to report certain information. Such information may include the amount of money spent, what type of work was performed, who performed the work, why the work was performed, and other information such as total mileage, who has used the vehicle, where the vehicle is located, and the company's internal identification code. This information may be used to calculate the cost per performance unit of a particular vehicle, calculate the reimbursement needs of individuals who have paid for such work, or to pay the service provider directly.

The task of keeping track of vehicle usage information has traditionally been done through handwritten reports filed in person or through the mail system. The company may distribute standard cards or a standard document which are then entered at a central location into the company files. The central company files are then utilized to track the usage information, pay bills to service providers or to a leasing company, or to keep track of periodic required maintenance and to issue orders for the same. In these situations, an individual user, or a person at a central garage, must fill out by hand the pertinent information and submit this information to the designated record keeping authority, wherein the information is then manually entered.

The process of keeping track of usage information is subject to many different problems and inefficiencies. It is time consuming, expensive, and tedious. Furthermore, individuals are not always on time when it comes to filling out the cards or reports and mailing them once they are completed. Additionally, errors may occur when the usage information is not written clearly or when the data entry staff misreads the information. If information is not timely entered into the system payments may not be made in a timely fashion and this wastes time for the individual customer and requires additional personnel expenses for an administrator.

### SUMMARY OF THE INVENTION

A more reliable and more efficient system is provided to track usage information. The system allows a company purchasing or leasing a fleet of vehicles to have the information about those vehicles, from oil change schedules to how often batteries are replaced, kept by a centralized data storage and reporting system. Furthermore, a method is provided that allows users of vehicles, whether the vehicles are owned or leased, to keep track of various expenditures relating to that vehicle, including the vehicle number, maintenance work performed, the money spent on gas and maintenance, vehicle mileage, etc. The system may also track the usage information and organize it in such a manner that allows for the automatic payment of services rendered, such as payments to repair shops or payments to a leasing company.

The system for reliably reporting information to a central data collection system may be based on the Internet. The Internet is a collection of computer networks that allows computer users to share files and other computer resources. Each computer connected to the Internet has a unique address whose format is defined by the Internet Protocol (“TCP/IP”). The Internet includes a public network using the TCP/IP and includes two kinds of computers: servers, which provide information and documents; and clients, which retrieve and display documents and information for users. As will be appreciated by those of ordinary skill in the art, as used throughout this specification the term “client” refers to a client computer (or machine) on a network, or to a process or programs, such as Web browsers, which run on a client computer, in order to facilitate network connectivity and communications. This specification will use the term “individual” or “user” when referring to a person using a client computer to access the server and enter usage information. Similarly, the term “server” will be used throughout this specification to refer to a server computer or computer system on a network, including the database attached to the server for storing information.

The “World Wide Web” (“Web”) is that collection of servers on the Internet that utilize the Hypertext Transfer Protocol (“HTTP”). HTTP is a known application protocol that provides users access to resources, which may be information in different formats such as text, graphics, images, sound, video, Hypertext Markup Language (“HTML”), as well as programs. HTML is a standard page description language which provides basic document formatting and allows the developer to specify “links” to other servers and files. Links may be specified via a Uniform Resource Locator (“URL”). Upon specification of a link by the user, the client makes a TCP/IP request to a Web server and receives information, which may be another “Web page” that is formatted according to HTML. Users can also access other pages on the same or other servers by following instructions on the screen, entering certain data, or clicking on selected icons.

Servers run on a variety of platforms, including UNIX machines, although other platforms, such as Windows 95, Windows NT, and Macintosh may also be used. Computer users can view information available on servers or networks on the Web through the use of browsing software, such as Netscape Navigator, Microsoft Internet Explorer, Mosaic, or Lynx browsers. A typical Web page is an HTML document with text, “links” that a user may activate (e.g. “click on”), as well as embedded URL's pointing to resources, such as images, video or sound, that the client may activate to fully use the Web page in a browser. Furthermore, icons are present which a user clicks on to submit usage information to the server, or to request information from the server. In some situations, these resources may not be located on the same server that provided the HTML document to the client. Furthermore, HTTP allows for the transmission of certain information from the client to a server. The server can then post this information on its web site, forward it on to another user or server, or save it to a database for later use.

In one embodiment of the present invention the system may relate to a client company that owns or leases one or more vehicles. The client company may pay a fee to a server company for tracking the information, compiling the information, and acting on the information, such as paying bills, servicing the vehicles, or compiling reports about the vehicles and their use. The client company may pay the server company to keep track of a fleet of vehicles that the client company owns, or that the client company leases, say from the server company itself. In other embodiments, the client company may in fact lease the vehicles from another company, or a combination of companies possibly including the server company, and pay the server company to track the fleet information, including bill consolidation.

In one embodiment of the present invention, a method may be provided for operating a server system adapted to provide on-line tracking of vehicle usage information by a server company for a client company. The method may comprise the steps of providing a database that is accessible by the client company, receiving usage information from the client company, storing in the database usage information received from the client company, compiling a customized report corresponding to said usage information, and transmitting said report to the client company.

In one embodiment of the present invention, a method may be provided for tracking usage information for a fleet of vehicles by a server system maintained by a server company. The method may comprise providing a database where usage information may be stored and maintained by a server company, receiving usage information from a client company, storing the usage information in the database, and the server company providing services to the client company relating to the stored usage information whereby the client company saves money.

In one embodiment of the present invention, a method may be provided for consolidating billing information for a vehicle fleet, the method may include collecting separate bills from an at least one service provider, the service provider having provided services on the vehicles in the fleet that is utilized by a client company, paying the separate bills to each service provider, compiling the total of each bill of from each of the service providers, sending one bill to the client company, wherein the client company only has to pay one bill for all of the services that were provided by the at least one service provider.

### BRIEF DESCRIPTION OF THE DRAWINGS

FIG. 1 is a block diagram overview of a client server system consistent with the principals of the present invention.

FIG. 2 is a block diagram of the hardware of a client interface of FIG. 1.

FIG. 3 is a block diagram of the server setup consistent with the principals of the present invention.

FIG. 4 is a flow chart of a method consistent with the principals of the present invention.

FIG. 5 is a diagram of a HTML a welcome page consistent with the principals of the present invention.

FIG. 6 is a diagram of a HTML log on page consistent with the principals of the present invention.

FIG. 7 is a diagram of a spreadsheet entry form consistent with the principals of the present invention.

FIG. 8 is a diagram of a HTML page entry page consistent with the principals of the present invention.

FIG. 9 is a block diagram of a bill pay method consistent with the principals of the present invention.

### DETAILED DESCRIPTION

The teachings of the present invention are applicable to many different types of computer networks and may also be used, for instance, in conjunction with direct on-line connections to databases. In addition to or alternatively, a telephone system may also be used to receive and distribute the information.

In one embodiment, a standard telephone may be used to communicate the usage information and may be used in conjunction with an IVR (Interactive Voice Response) communication system. The telephone may have an input/output device that receives and sends information over the telephone communication system. An individual entering the usage information can use either the pad or the microphone. The spoken or keypad entered information may be transferred over the telephone system through various known methods.

The system and method of the present invention will be described generally with reference to cars, light duty trucks, medium duty trucks, heavy duty trucks, trailers and equipment, but have application in the management of other types of vehicles as well. With regard to the references in this specification to computers, the computers may be any standard computer including standard attachments and components thereof (e.g., a disk drive, hard drive, CD player or network server that communicates with a CPU and main memory, a sound board, a keyboard and mouse, and a monitor). The processor of the CPU in the computer may be any conventional general purpose single- or multi-chip microprocessor. In addition, the processor may be any conventional special purpose processor such as a digital signal processor or a graphics processor. The microprocessor has conventional address lines, conventional data lines, and one or more conventional control lines. With regard to references to software, the software may be standard software used by those skilled in the art or may be coded in any standard programming language to accomplish the tasks detailed below.

In one embodiment, the server database may be maintained by what is referred to as a “server company.” The server company may be the company or entity keeping track of the usage information by maintaining the database. The company or entity that is leasing or purchasing the vehicles, from the server company or elsewhere, and for whom usage information is being tracked, may be known as a client company. The server company may be tracking the information on its own leased vehicles in the possession of the client company, or performing the tracking services for the client company for a fee. In either case, the present description will utilize the term server company for that organization that maintains the server database and will utilize the term client company for that organization that operates the vehicles.

Finally, various embodiments are described in terms of a “user” entering the information. The “user” may be an individual who enters data for a vehicle the individual personally uses, an individual working at a garage in the employ of the client company, or others. This information may also be entered via an automated database, which can periodically download information from a database maintained by the client company, to the server company's database.

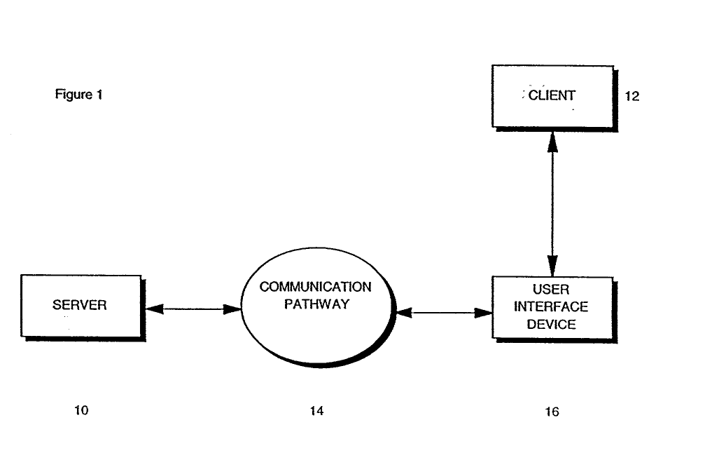

FIG. 1 is a block diagram illustration of a network based on a client-server model. The network comprises one or more database servers 10, one or more clients 12, a user interface device 16, and a communication pathway 14. The clients 12 communicate with the servers 10 over the communication path 14 via the user interface device 16. The communication pathway 14 may be through the Internet or other suitable telecommunications paths. A suitable network protocol, such as the TCP/IP protocol, may be used for the communications. The user interface device 16 may be any computer or web interface device known to those skilled in the art. The application server 10 may include a web server that provides the computer information. The web server and the database server 10 may exist within a single computer or computer system or can also be separate entities. As referred to herein, the server 10 includes both possibilities. The server 10 allows access by the clients 12 to various network resources through communication pathway 14.

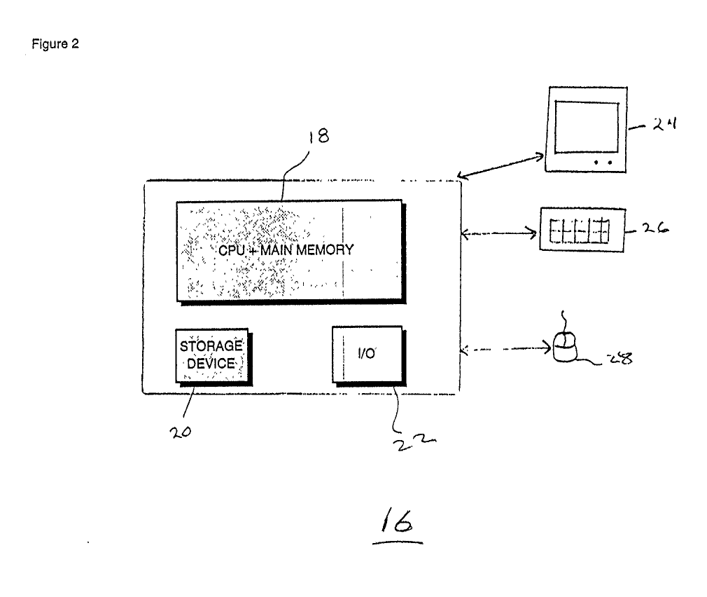

FIG. 2 is a block diagram of a representative client interface device 16. As described above, the client's user interface device 16 may be any conventional computer known to those skilled in the art. In FIG. 2, the client user interface device 16 is a computer that includes a central processor unit (“CPU”) and main memory 18, an input/output interface 22 for communicating with various databases, files, programs, and networks (such as the Internet), and one or more storage devices 20. The storage devices 20 may be disk drive devices or CD ROM devices. The client computer may also include a monitor 24 or other screen device and an input device such as a keyboard 26 and/or a mouse 28. In order to facilitate use over the Internet, the client computer could have software programs contained in the main memory 18 or the storage 20 which can be used by the CPU 18.

In some embodiments, a Web browser, which is a known software tool used to access the Web via a connection obtained through an Internet Service Provider, may be part of the software programming utilized. A variety of browsers known to those skilled in the art may be used within the scope of the present invention. As explained above, a Web server may allow access to so-called “Web sites” and “Web pages.” Once the Web browser has accessed these pages through the Web server, the HTML page may be downloaded through the input/output interface 22. The central processing unit 18 will use the browser software package to interpret the information and display it on the monitor 24. The software may also contain other software or programs which will allow the user to fill in information on the screens and to exchange data with the server 10.

The memory 18 or the storage device 20 may also contain configuration software. This software will enable the computer to configure the downloaded HTML Web page to make it an interactive device. The configuration software may allow a user to move from one field to another on the downloaded Web page to select options or enter usage information.

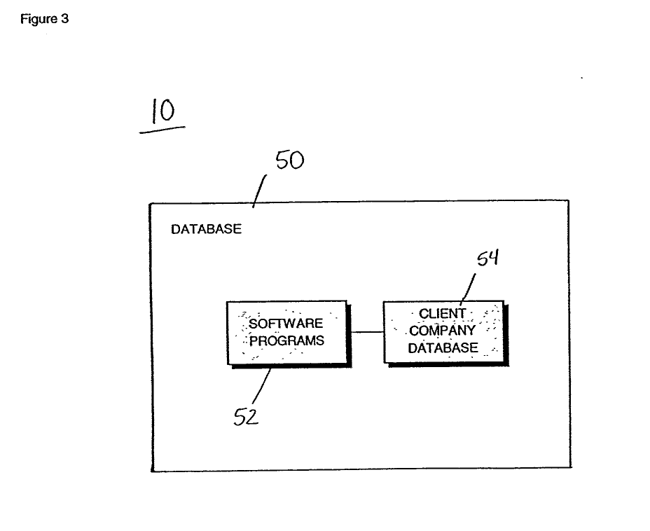

FIG. 3 illustrates server 10. The server 10 may contain programs that run on the server-side to process requests and responses from the user's interface 16, which sends the proper information to the client, and performs compilation and storage functions. The server 10 may send out web pages in HTML format for the user to download, interpret with his/her computer, and view on the monitor.

The server 10 may be configured to incorporate the client database 50 or, in an alternative embodiment, the server 10 may simply be connected to a client database at a remote site in much the same way as the server 10 and user interface 16 are connected. The server 10 may further contain software programs 52 that control the interface with the communications pathway 114 of FIG. 1. The server 10 may further control the operations of the database 50 and the compiling of the usage information for the generation of reports.

The database storage area 50 of the server 10 may be further organized so that each client company database 54 is separately maintained. In alternative embodiments, the data within database 54 may be mixed with that from other clients for a more accurate vehicle database for cost analysis. The information entered by the user may be placed in a designated area according to what usage information is entered, which individual user entered the usage information, what specified period, and also what type of information is entered. The information may be further organized by distinguishing between what information is directly accessible by the users and client companies and what information is only accessible to the client company and users by requesting a report. The server company may do any number of manipulations of the usage information stored in the database, such as calculating the total cost of the vehicles, calculating the cost to use different types of vehicles, issuing reminders for scheduled maintenance or other calculations may be facilitated.

Alternatively, the database 50 may be maintained at the client company, whether it owns or leases the vehicles, or at the server company. The physical location of the database is not critical.

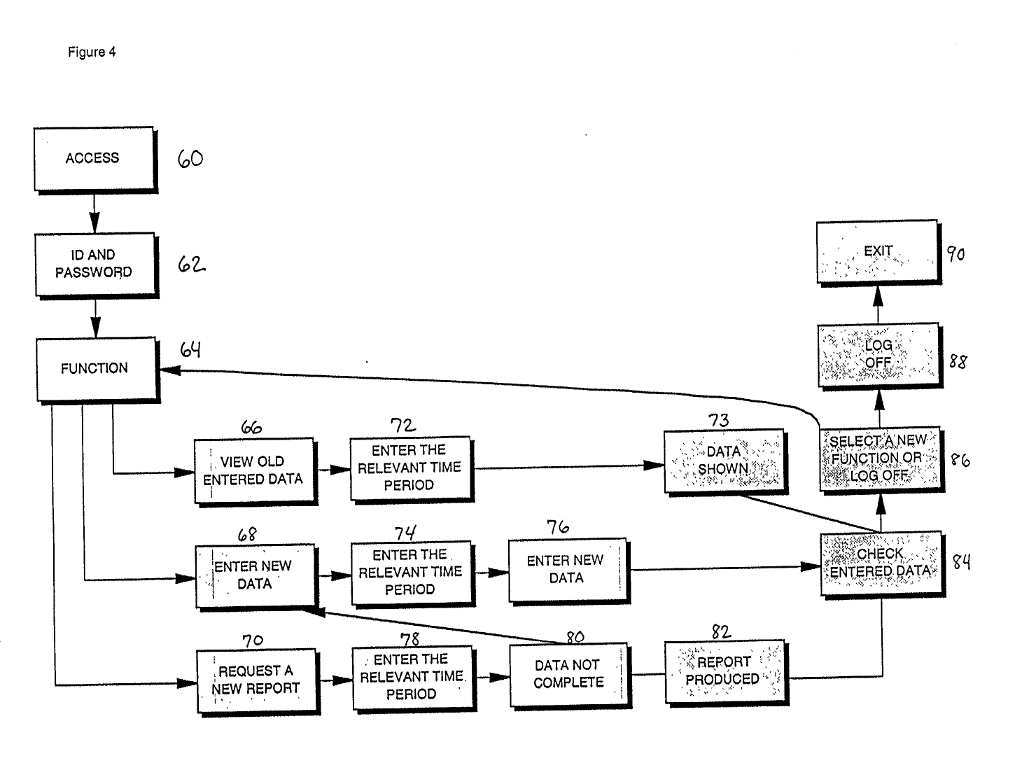

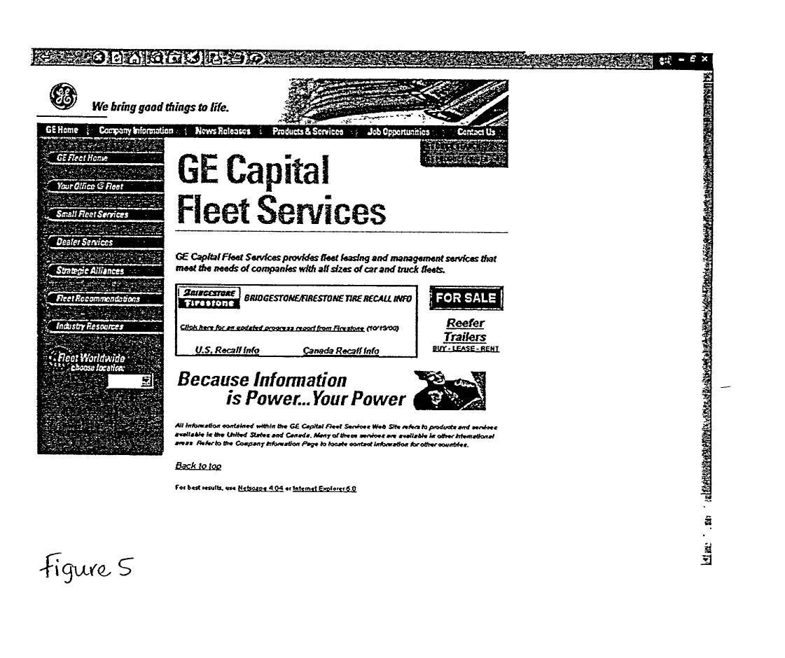

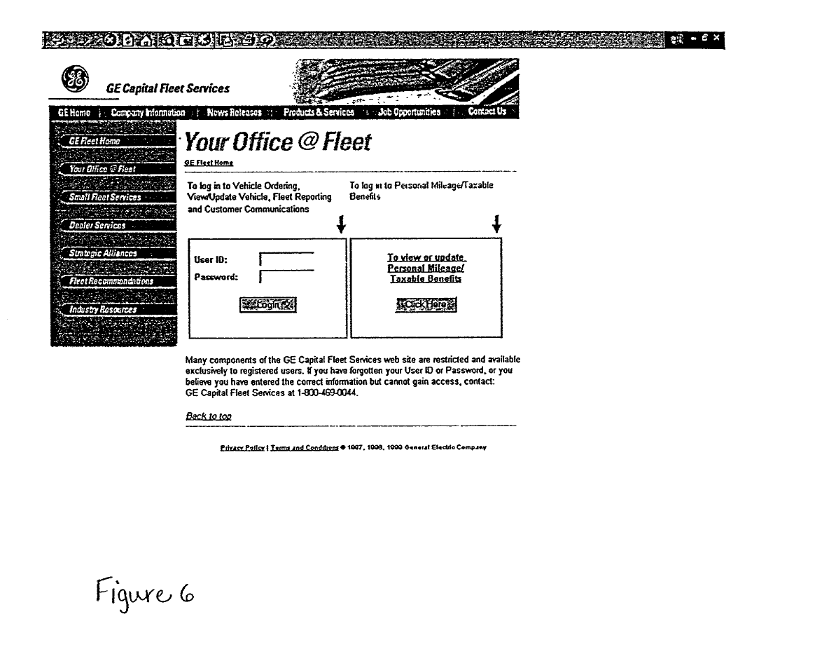

FIG. 4 illustrates a flow chart of the acts of logging onto the system and inputting usage information into the server database. As illustrated in FIG. 4, the individual customer may access the Internet application by typing in the appropriate TCP/IP address and accessing the HTML formatted web page as shown in FIG. 5 from the server company's server. The user may be then directed to a welcome page such as shown in FIG. 6. Once the connection is made, the user may log on to the database by entering an identification and a password 62. One example of an identification and password for the internet access may be a number or character string. The identification and password may indicate to the database what person is entering the data, what garage is entering the data, or for what client company the user is entering the information. In alternative embodiments, passwords may be issued for an organizational entity as a whole or for an individual user.

Once the user is cleared onto the database, then the user may begin to perform functions. The server database prompts the user to select a function the user wishes to perform 64. The user may select a series of options 66-70:

| | |
|---|---|
| A. | VIEW OLD ENTERED DATA (66) |
| B. | ENTER NEW DATA (68) |
| C. | REQUEST A NEW REPORT (70) |

If the user desires to select option A, the server database may first prompt the user to select a relevant period for viewing the usage information 72. The server database may then display previously entered usage information 74.

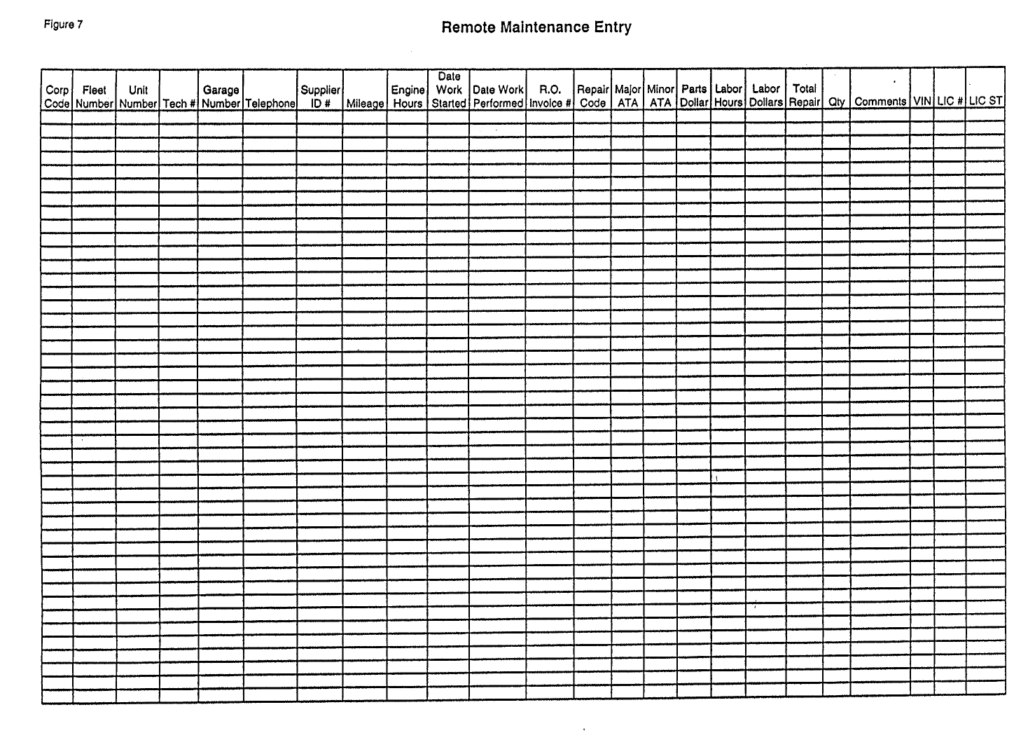

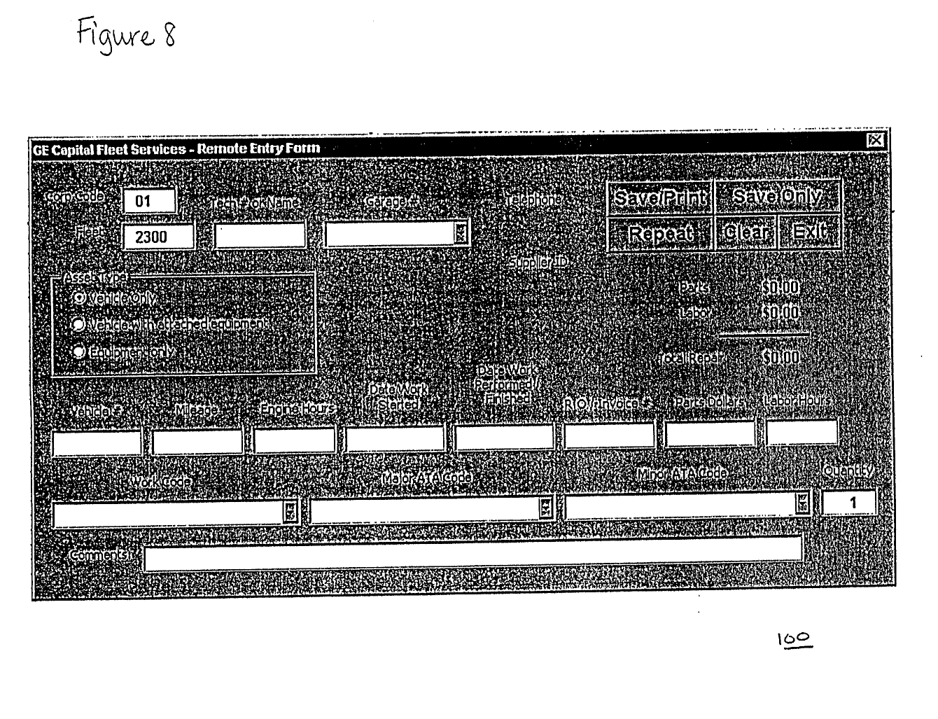

Any manner of displaying the data may be utilized, such as a spreadsheet layout illustrated in FIG. 7, or as an HTML page as illustrated in FIG. 8. If the data for the selected time period has not been completely entered, the server company's database may prompt the user to enter in the remaining data, in which case the user would be sent to option B.

Upon selection of option B, the user may enter new usage information data 68. The user may be directed to a remote entry form such as illustrated in FIG. 8. As above, the user may be prompted to select a specified period for which to enter the usage information 74. Once the server database is selected, the user may enter the usage information 76. Examples of the types of usage information which may be entered are illustrated in FIG. 7, such as:

USAGE INFORMATION THAT MAY BE DISPLAYED/ENTERED

MILEAGE

ENGINE HOURS

DATE WORK STARTED

DATE WORK PERFORMED

R.O. INVOICE #

REPAIR CODE

MAJOR REPAIR CODE

MINOR REPAIR CODE

PARTS DOLLAR

LABOR HOURS

LABOR DOLLARS

TOTAL REPAIR

QUANTITY

COMMENTS

VIN

LICENSE NUMBER

LICENSE STATE

As illustrated in FIG. 7, many different types of information may be entered and tracked on a concurrent basis. The usage information may be entered as a single bit of usage information, for example, the odometer reading at the time of vehicle or how much money was spent on an oil change, or as a whole series of interrelated bits of information such as would be associated with vehicle repair. This usage information may be entered in units, such as US dollars, Canadian dollars, miles, kilometers, or other appropriate units.

Alternatively, the usage information may be entered in a spreadsheet format, with a garage or organization downloading all of the client company's usage information to the server company's database about one vehicle, a group of vehicles, or an entire fleet, at one time. A spreadsheet such as illustrated in FIG. 7 may be used for this purpose. The user may first enter the information onto a spreadsheet that is on the client company's database or on the user's personal computer. When the user then logs onto the database, the entire contents of the spreadsheet may be sent as a file to the server. The spreadsheet format may facilitate the batch entry of data by a client company's garage or a client company's server without having to continuously log on and off of the system and database of the server company.

FIG. 8 illustrates an example HTML page for an individual vehicle entry 100. The corporate code and fleet number may identify the client company. The vehicle number may identify the car. In the other blocks, routine information may be entered about the car of the present embodiment, including everything from the corporate code to the mileage and license number. As may be appreciated, just about any information about the vehicle may be tracked in such a layout. This particular page focuses on a repair done on the vehicle, asking for information on when work was performed, the price for parts and labor, and the invoice number. Other blanks may be allowed for additional comments and codes concerning the vehicle and the work performed.

ADDITIONAL FIELDS A CUSTOMER CAN UPLOAD

| | |
|---|---|
| Corp. Code | 2 digit number (01, 44, 67, or 98) |
| Fleet Number | Maximum 6 digit integer |
| Unit Number | Any 8 character text string |
| Tech # | Any 8 character text string |
| Garage # | Any 25 character text string |
| Telephone | Any 10 character text string |
| Supplier ID# | Any 10 character text string |
| Mileage | Maximum 7 digit number |
| Engine Hours | Maximum 7 digit number |
| Work Started | Date field |
| Work Performed | Date field |
| R.O./Invoice # | Any 8 character text string |
| Repair Code | Any 40 character text string |
| Major Repair Code | Any 40 character text string |
| Minor Repair Code | Any 40 character text string |
| Parts Dollars | Currency field |
| Labor Hours | Maximum 7 digit number + 2 decimal |
| Labor Dollars | Currency field |
| Total Repair | Currency field |
| Qty | Maximum 6 digit number + 2 decimal |
| Comments | Any 75 character text string |

USER DEFINED LISTS

| | |
|---|---|
| Repair Codes | Any 40 character text strings |
| Garage Code | Any 40 character text strings |
| Garage Phone | Any 10 character text strings |
| Labor Rate | Currency field |
| Supplier ID | Any 10 digit integer |

USER SELECTABLE DEFAULT SETTINGS

| | |
|---|---|
| Corp | 2 digit number (01, 44, 67, or 98) |
| Fleet | Maximum 6 digit integer |
| Distance | Miles/Kilo |

| | | |
|---|---|---|
| Invoice | Invoice | Required/Invoice |
| | | Optional/Invoice Not Available |
| Default Asset Type | Vehicle | Only/Vehicle with |
| | | Equipment/Equipment Only |

| | |
|---|---|
| Next Invoice Number | Maximum 10 character text string |
| Invoice Heading | Maximum 40 character text string |

With reference to the above fields, the first column illustrates possible fields for entry, with the second column showing an example form the usage information may take for that field. The user enters the information and then moves onto the next field such as by pressing the ENTER key or the TAB key. Other ways to jump to the next field may also be utilized. In general, the fields may be arranged such that entering a particular field will be followed by entering usage information for a related field. Limitations set out above, such as the 75 character maximum imposed on the comments, may be changed by those reasonably skilled in the art as needed or desired.

The user may alternatively select option C (70 in FIG. 4) to request a new report. The user may then be prompted to enter the reportable period for which the report is requested 78. If all of the relevant usage information has not been entered for that reportable period, then the user may be prompted to enter in the new usage information before the report can be properly compiled and the information reported 80 (see above). Once the user completes entering the usage information, the report may be produced. This system may be set up to automatically verify the accuracy of the entered information by looking at the unit entered, for example, if too large of a monetary number is entered into the system, the system could prompt the user to validate the amount spent. In alternative embodiments, the reports may be issued automatically rather than being requested on demand. However, the report requested on demand feature may be desirable for the client company for various reasons known to those reasonably skilled in the art.

Once the usage information is displayed, the report requested, or the usage information entered, the user may then go back to the beginning to perform another operation 86. Alternatively, the user can exit the database by logging off 88. To exit the system, the internet user may first log off 88 the server database. Logging off may insure that if the computer is left on, and connected to the server database, that another user or passerby could not then alter the previously entered usage information or enter incorrect usage information. To log off 88 an internal system, the user may simply turn off or abandon the user's personal account. In an internal system, logging off of the system is not as important as when the terminal is accessible to the public. Once the user is logged off and exited 90 from the system, the server database may then send the information to be compiled.

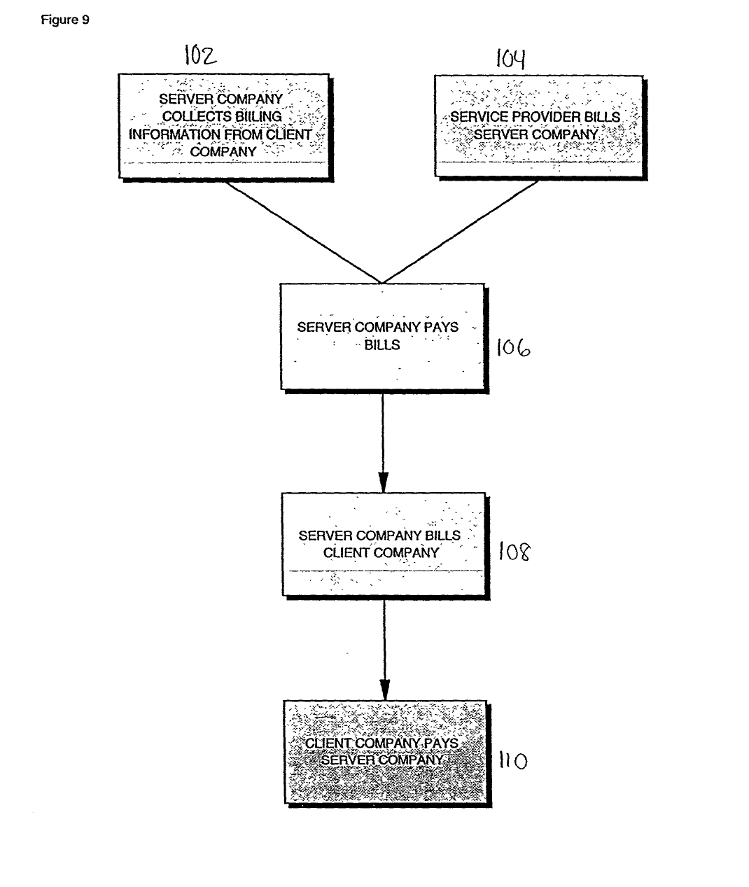

As illustrated in FIG. 9, in the present embodiment the server company may provide bill consolidation services to the client company. The server company first collects the billing information from the client 102. Alternatively, the client company may instruct the service providers to invoice the server company directly 104 for the services performed, reducing even more the effort expended by the client company. In one embodiment, the server company may employ personnel to enter into the system such bills that are sent directly to the server company for payment. In other embodiments, the client company may enter this billing information into the database or simply forward the bills to the server company for entry organizing them in any manner. In other embodiments, a combination of direct billing 104 or forwarded billing 102 may also be used.

Once the server company has the billing information, the server company may then pay the service providers directly 106. The server company may then compile an itemized report of the bills paid, and thereafter send one bill to the client company 108. This service provided by the server company only requires that the client company submit one payment 110 for all of the bills in a given time period, saving the time and effort of paying each individual bill for the vehicle fleet.

The system and method reduces expenditures in personnel and equipment that a client company must expend to maintain a vehicle fleet. The client company can have a vehicle fleet without staffing a whole department to keep track of the vehicles, maintain the vehicles, or service the vehicles. The user of each vehicle may individually input the usage information directly into the database.

Advantageously, the server company can produce reports for the client company. Since the server company may perform this service for one or more client companies, the client company can receive cost information based on a greater number and variety of vehicles than it may individually utilize. The server company can therefore provide valuable advice if the client company wishes to expand its vehicle fleet, to change the makes or the models of the vehicles in its fleet, or to reduce its vehicle fleet. Enabling a better analysis of a client company's needs for vehicle fleet decisions helps the client company further reduce expenditures. Inherent in these decisions is the analysis of different aspects of different vehicles, finding out what about the vehicles worked well and what did not. The reports and analysis done by the server company may be much more beneficial to the client company because it is based on a database larger than that maintained for the client company alone, allowing a better statistical sampling

The server company can also provide a bill payment plan to the client company. Whether the bill is sent directly to the server company, or the bill is forwarded to the server company from the client company, the server company may pay the bill without the client company expending the resources required to maintain its own billing department. The client company may pay the one consolidated bill at the end of each billing period, saving money spent on personnel and facilities.

As will be appreciated by those of ordinary skill in the art, while the preceding discussion sets forth various embodiment of the method and system of the present invention, these implementations are not intended to be restrictive of the appended claims, nor are they intended to imply that the claimed invention has limited applicability to one type of computer or telephone network. While the principles underlying the Internet and the Web have been described in some detail above and below in connection with various aspects of the present invention, this discussion is provided for descriptive purposes only and is not intended to imply any limiting aspects to the broadly claimed methods and systems.

While the present invention has been described with reference to several embodiments thereof, those skilled in the art may recognize various changes that may be made without departing from the spirit and scope of the claimed invention. Accordingly, this invention is not limited to what is shown in the drawings and described in the specification but rather as indicated in the appended claims. Any number or ordering of the elements in the following claims is merely for convenience and is not intended to suggest that the ordering of the elements of the claims has any particular significance other than that otherwise expressed by the language of the claims.

1. A method for tracking vehicle usage information, the method comprising:
providing a database that is accessible by a client company, the database provided by a server company;
receiving usage information from the client company; and
storing in the database usage information received from the client company, wherein the server company may provide services to the client company based on the database of usage information.

2. The method of claim 1 wherein the client company is leasing at least one vehicle from the server company.

3. The method of claim 1 wherein the client company owns at least one vehicle for which the usage information is being tracked.

4. The method of claim 1 wherein the usage information is maintained by the client company before forwarding the usage information to the server company.

5. The method of claim 1 wherein receiving the usage information from the client company further comprises a user entering the database and entering the usage information.

6. The method of claim 5 further comprising:
storing in the server database billing information consisting of bills from services provided by one or more service providers who have worked on one or more of the vehicles;
the server company paying the bills to the service providers; and
the server company billing the client company for all of the bills the server company has paid on behalf of the client company.

7. The method of claim 1 further comprising the server company compiling a report, the report forwarded to the client company by the server company.

8. The method of claim 7 wherein the act of compiling the report further comprises the server company:
totaling information relating to a desired usage characteristic;
forming the totaled information into a report; and
forwarding the report to the client company.

9. The method of claim 8 wherein the usage information is transferred to the database at the server system via the Internet.

10. The method of claim 9 wherein the method further comprises electronically soliciting the usage information from a client company; and electronically receiving the usage information from a client company computer.

11. The method of claim 10 wherein the act of electronically receiving the usage information further comprises an at least one field designed to receive an at least one piece of usage information.

12. The method of claim 11 wherein the usage information is transferred to the database at the server system via a telephone interactive response system.

13. The method of claim 12 wherein the usage information stored in the server system may be accessed by a user at the client company.

14. A method for tracking usage information for a fleet of vehicles by a server system maintained by a server company, the method comprising:
providing a database where usage information may be stored and maintained by a server company;
receiving usage information from a client company;
storing said usage information in the database; and
providing services to the client company relating to the stored usage information whereby the client company saves money.

15. The method of claim 14 wherein receiving usage information further comprises:
a user logging onto the server system;
the user entering the usage information for a specific vehicle; and
the user logging off of the system.

16. The method of claim 15 wherein receiving the usage information further comprises:
compiling a batch of usage information on a client database maintained by the client company;
downloading the batch of usage information to the database at the server company; and
the server company storing the batch of the usage information.

17. A method of consolidating billing information for a vehicle fleet, the method comprising:
collecting separate bills from at least one service provider, the service provider having provided services on the vehicles in the fleet that is utilized by a client company;
paying the separate bills to each service provider;
compiling the total of each bill of from each of the service providers; and
sending one bill to the client company, wherein the client company only pays one bill for all of the services that were provided by the at least one service provider.
